(19) United States
(12) Patent Application Publication
(10) Pub. No.: US 2004/0149949 A1
(43) Pub. Date: Aug. 5, 2004

(54) Needle valve-related arrangement

(76) Inventors: Nils Olof Eriksson, Enskede (SE); Torsten Lundberg, Stockholm (SE)

Correspondence Address: BANNER & WITCOFF, 1001 G STREET N W, SUITE 1100, WASHINGTON, DC, 20001, US

(21) Appl. No.: 10/477,131

(22) PCT Filed: May 6, 2002
(86) PCT No.: PCT/SE02/00868

(30) Foreign Application Priority Data
May 10, 2001 (SE) 0101650-0

(51) Int. Cl. F16K 25/00

(52) U.S. Cl. 251/186; 251/903; 251/264

(57) ABSTRACT

The invention comprises a needle valve-related arrangement (1) with a rotating spindle (11) in an enclosure, whereby a rotary movement of the spindle in one direction induces movement in a firs valve part (12) on the spindle in a first direction towards a second valve part (13) and vice-versa. Pressure to create sealing interaction of the valve parts (12, 13) is achieved with the aid of a spring arrangement (35).

### FIELD OF INVENTION

The present invention relates generally to a needle valve-related arrangement and more particularly to a needle valve-related arrangement with a rotating spindle mounted in an enclosure. Rotary movement of the spindle in one direction induces helical movement of a first valve part attached to the spindle in a first direction towards a second valve part and vice-versa.

It is assumed that spindle movement in a first direction moves the valve parts towards a sealing position, whereas spindle movement in a second direction moves the valve parts to an opening position.

The valve part attached to the spindle normally consists of a conical pin or needle, whereas a valve part, referred to as the valve seat, in an enclosure consists of a channel for accommodating the said needle.

A needle valve-related arrangement of this kind was developed for use in a respiratory device, thereby offering simple and exact regulation and/or dispensing of a flow of gas or fluid, preferably a flow of gas, through the valve arrangement.

### DESCRIPTION OF THE PRIOR ART

Needle valve-related arrangements of the kind described above are generally known from a plurality of different embodiments, devised for different technical applications.

Thus, varying the cone angle of a first valve part in the form of a conical needle, in relation to the valve seat in and constituting a second valve part, is previously known.

Varying the angle of gradient of the helical movement created by rotating the spindle is also known.

A small cone angle and a small angle of gradient require greater rotary movement to permit the passage of a small flow than a large cone angle and greater angle of gradient.

Thus, it is known that the smaller the cone angle is selected and the smaller the angle of gradient is chosen, the greater the tensioning and sealing force arising between the sealing surfaces of the two valve parts. On the one hand, this results in good sealing of the valve parts but, on the other hand, this also greatly increases the risk of valve parts and their sealing surfaces jamming in their conjoined, sealed position.

In this known technique, and especially with small cone angles and small angles of gradient, identifying a rotary position, at which sealing pressure between the valve parts is sufficient, from appearing resistance to spindle rotation has proved to be difficult. Experience suggests or indicates that operators tend to greatly exceed an adequate sealing pressure, thereby risking damage and jamming of the spindle against the valve seat.

A conical needle could sustain pressure damage from a circular sealing gasket seal against the needle.

Sealing pressure will be or is directly related to perceived resistance to torque in spindle motion.

Especially in needle valve-related arrangements, employing small cone angles, means for limiting the sealing pressure between valve parts have previously been proposed to prevent this pressure from being directly related to perceived torque or resistance in spindle movement.

Here, the terms “torque” or “resistance” mean that a rotary movement for regulating flow through a valve can be performed with a selected torque. But the amount of torque required for rotating the spindle increases once the valve parts seal against one another.

The measures and means proposed here are based on the arrangement of a one-way friction clutch between a knob for imparting a desired rotary movement to the spindle and a spindle shaft.

The friction clutch is therefore active during a rotary movement of the spindle to a position sealing the valve's valve parts. The clutch is blocked or locked during rotation of the spindle to a position separating the valve parts.

Practical applications of valve arrangements, equipped with friction clutches of this kind, show that these friction clutches frequently impart varying torque on the spindle in its slip state or position, thereby causing appearing sealing pressures to vary considerably, despite the measures proposed.

### DESCRIPTION OF THE PRESENT INVENTION

Technical Problems

When taking into consideration the technical deliberations that a person skilled in this particular art must make in order to provide a solution to one or more technical problems that she/he encounters, it will be seen that, on the one hand, it is necessary initially to realise the measures and/or the sequence of measures that must be undertaken to this end and, on the other hand, to realise which means is/are required to solve one or more of the problems. On this basis, it will be evident that the technical problems listed below are relevant to the development of the present invention.

It will be seen, when considering the present state of the art as described above, that a technical problem resides in providing conditions with the aid of simple means that will enable the valve parts, in a needle valve-related arrangement, to provide a sufficiently high and appropriate sealing pressure, related to the cone angle of a conical needle and a valve seat, essentially independent of occurring demands for an increase in torque or resistance in spindle movement.

It will also be seen that a technical problem resides in being able to offer, in a valve of the kind described above, a distinct, sealing rotational position using sufficiently high torque for a rotary movement without accordingly increasing the sealing pressure occurring.

It will also be seen that a technical problem resides in being able to offer a design with displaceable valve seat, active under the intended sealing pressure, and that is pressed against a stop facing the spindle.

It will also be seen that a technical problem resides in being able to provide an arrangement offering the possibility of rotating the needle with a helical motion to detach it from the seat, when the needle has jammed against the seat.

It will be seen that a technical problem resides in realising the importance of and the advantages associated with achieving the desired sealing pressure for sealing the valve parts with the aid of a spring arrangement, acting on the valve seat.

It will be seen that a technical problem resides in being able to realise the importance of and advantages associated with allowing the first valve part to consist of a conical needle and the second valve part to consist of a seat. This seat could be a grinded or conical seat or a seat that is part of a hole rim.

It will be seen that a technical problem resides in realising the importance of and advantages associated with having the second valve part be devised as an axially moveable body, such as a cylindrical body.

It will be seen that a technical problems resides in realising the importance of and advantages associated with having the said spring arrangement arranged and pre-tensioned to keep the body pressed against a seat and, after application of a desired sealing pressure, having the needle and spindle successively move the body with a helical motion against the action of the spring arrangement.

It will be seen that a technical problem resides in realising the importance of and advantages associated with providing the said moveable, cylindrically shaped body with a sealing gasket acting against a cylindrical inner surface of a middle or an intermediate part in the valve housing.

It will be seen that a technical problem resides in realising the importance of and advantages associated with providing said middle part with a number of support surfaces against which support surface on the spindle and valve part are devised to interact.

It will be seen that a technical problem resides in realising the importance of and advantages associated with having one valve part, under a sealing pressure exerted by the spring arrangement, moving the other valve part against the force exerted by the spring, when these support surfaces interact.

It will be seen that a technical problem resides in realising the importance of and advantages associated with having the said spring arrangement to be active between a shoulder on an inlet part and a central hole in the cylindrical body.

It will be seen that a technical problem resides in realising the importance of and advantages associated with having a central hole in the cylindrical body interacting with the second valve part.

Solution

Thus, the present invention utilises prior art technology for a needle valve-related arrangement, that has a rotating or rotatable spindle in an enclosure or valve housing. A rotary movement imparted to the spindle in one direction causes the movement of a first valve part, attached to the spindle, towards a second valve part and vice-versa.

With the intention of solving one or more of the aforesaid technical problems, it is proposed, in accordance with the present invention, that a sealing pressure, achieved with the aid of a spring arrangement, essentially independent of any torque applied to the spindle, be applied to the valve parts to seal them together.

According to proposed embodiments that lie within the scope of the invention, it is proposed that said first valve part consist of a conical needle and that said second valve part consist of a seat.

It is further proposed that said second valve part be devised in a body moveable inside the valve housing.

It is further proposed that the said spring arrangement be arranged and pre-tensioned, in order to move said body and press it against said seat.

It is further proposed that the said moveable and preferably cylindrical body be provided with one or more sealing gaskets, preferably one sealing gasket acting on a cylindrical inner surface on a middle or intermediate part in the valve housing.

The middle part has a number of support surfaces against which a support surface, encircling the valve part, on the spindle is devised to interact with a distinct detent for said rotary movement.

This also conveys the advantage that one valve part, under sealing pressure exerted by said spring arrangement, is able to move the other valve part, against the effect or force from the spring arrangement, when the support surfaces interact.

It is further proposed that the said spring arrangement be active between a shoulder at the inlet and a central hole in the moveable body.

The central hole in the body interacts with the second valve part.

Advantages

The advantages primarily conveyed by a needle valve-related arrangement, with the characteristics of the present invention, reside in the provision of features providing a distinct rotational position for the spindle against an enclosure or valve housing and in which the sealing pressure, between a first valve part and a second valve part, can be kept constant and essentially independent of the spindle's rotational position, in relation to the enclosure in the closed position.

The sealing pressure between the first valve part and the second valve part is maintained with the aid of a spring arrangement throughout the spindle's closing movement.

A closed valve is perceived as a stop between interacting surfaces after the valve has been closed and sealed.

The primary characteristic features of a needle valve-related arrangement, in accordance with the present invention, are set forth in the characterising clause of the following claim 1.

### BRIEF DESCRIPTION OF THE FIGURES

One proposed embodiment of a needle valve-related arrangement, displaying the significant features of the present invention, will now be described in greater detail, referring to the accompanying drawings, in which:

FIG. 1 is a side view of the needle valve-related arrangement,

FIG. 2 shows a longitudinal section of part of the arrangement according to FIG. 1 when the first valve part initiates sealing interaction with the second part under sealing pressure, exerted by a spring arrangement, and

FIG. 3 shows an enlarged part of the arrangement according to FIG. 2.

### DESCRIPTION OF THE PROPOSED EMBODIMENT

It should be pointed out right from the start that in the following description of a proposed embodiment with the significant features of the invention, clarified with the following drawings, we have used terms and special terminology for the primary purpose of clarifying the inventive concept.

However, it should be kept in mind that the terms used should not be regarded as restricted to the terms used and selected here but shall be understood to mean that each term is to be interpreted as encompassing all technical equivalents functioning in the same manner or essentially the same manner in order to achieve the same or essentially the same purpose and/or technical effect.

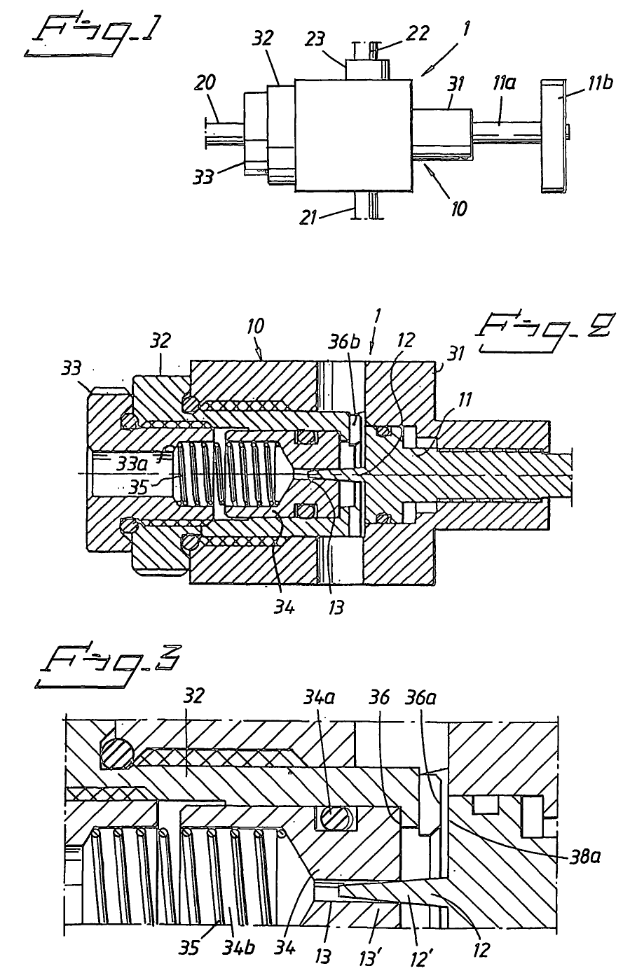

FIG. 1 accordingly shows a side view of a needle valve-related arrangement 1, comprising an enclosure or valve housing 10 and a rotating or rotatable spindle 11 in the enclosure. The shaft 11a of the spindle 11 can be rotated by the application of torque by a knob 11b.

Rotation of a spindle or shaft 11 in one direction causes movement of a first valve part 12 on the spindle in a first direction, towards a second valve part 13 and vice-versa.

FIG. 1 also shows a tube 20 for incoming fluid, such as an incoming gas and the reference numeral 21 illustrates a first outlet line and reference numeral 22 illustrates a second outlet line.

A flow or pressure restricting valve 23 could be used with the arrangement 1 and in conjunction with the line 22, for an application shown below in greater detail.

The needle valve-related arrangement 1 has an enclosure or valve housing 10 consisting of a first end part 31, a middle or intermediate part 32 and a second end part 33. The nature of the different parts is evident from FIGS. 2 and 3.

FIGS. 2 and 3 show that the first valve section 12 consists of a conical needle 12′, and the second valve part 13 consists of a seat 13′.

The seat 13′ can consist of the rim area of a hole 13, or the seat 13′ can have a tapered shape tailored to the conical shape of the needle 12′. The latter conformation should be in the shape of a grinding.

The second valve part 13 with the seat 13′ is devised in a body 34 that is moveable inside the valve housing's middle section 32.

The said spring arrangement 35 is arranged and pre-ensioned to keep the body 34 pressed against an inner seat 36 formed in the middle section 32.

The said moveable cylindrical body 34 is also provided with a sealing gasket 34a. This sealing gasket 34a fits into a groove in the cylindrical inner surface of the middle part 32.

The middle part 32 has a number of external support surfaces, whereby one of these has been allotted the reference numeral 36a, that interacts with a support surface 38a on the spindle that encircles the valve part.

When the support surfaces 36a and the support surface 38a come into contact, one valve part 12, acted upon by sealing pressure exerted by the spring arrangement 35, has moved the second valve part 13 and the body 34 to a maximum degree against the force of the spring.

A passage 36b between the support surfaces 36a allows a medium to pass the valve parts and reach the tubes 21, 22.

The said spring arrangement 35 is active between a shoulder 33a, on the part 33 allotted the inlet line 20 and a central hole 34b, formed in the moveable body 34.

The central hole in said body 34 interacts with the second valve part 12.

The use of a flow or pressure restricting means 23 means that an opening of the needle valve creates a large passage to allow released medium to flow through the outlet line 21 and only allows very limited passage through the means 23 and the tube 22.

It is evident that these flows will be in relationship to the extent to which the needle valve is opened and the amount of pressure in the inlet line 20.

The application suggested here is specially devised for use in respiratory equipment, shown and described in greater detail in the international patent publication PCT/SE/00 00910, and more as a valve intended for achieving required PEEP pressure.

It will be understood that invention is not restricted to the aforementioned and illustrated exemplifying embodiment thereof and that modifications are possible within the scope of the inventive concept as defined in the following claims.

1. A needle valve-related arrangement with a rotating or rotatable spindle in an enclosure or a valve housing, whereby rotary movement of said spindle in one direction causes movement of a first valve part on the spindle towards a second valve part and vice-versa, characterized in that a pressure, employed for a sealing of the valve parts, is achieved with the aid of a spring arrangement.

2. An arrangement according to claim 1, characterized in that said first valve part consists of a conical needle, and said second valve part consists of a seat.

3. An arrangement according to claim 1 or 2, characterized in that said second valve part is in the form of a moving or movable body.

4. An arrangement according to claim 1 or 3, characterized in that the said spring arrangement is arranged and pre-tensioned to move said body towards a seat.

5. An arrangement according to claim 4, characterized in that the said movable, cylindrically shaped body is provide with a sealing gasket, which presses against a cylindrical inner surface on the middle part.

6. An arrangement according to claim 1 or 4, characterized in that said middle part has a number of support surfaces devised to interact with a support surface on the spindle and encircling said middle part

7. An arrangement according to claim 1 or 6, characterized in that during the interaction of support surfaces, one valve part, subjected to a sealing pressure exerted by the spring arrangement, moves the other valve part against the force of a spring force.

8. An arrangement according to claim 1 or 3, characterized in that the said spring arrangement acts between a shoulder in the inlet line and a central hole in the moveable body.

9. An arrangement according to claim 8, characterized in that said central hole in the body interacts with said second valve part.
